(19) United States
(12) Patent Application Publication
(10) Pub. No.: US 2025/0368798 A1
(43) Pub. Date: Dec. 4, 2025

(54) METHOD FOR UPCYCLING POLYURETHANE THERMOSETS INTO THERMOPLASTICS VIA SMALL-MOLECULE CARBAMATE-ASSISTED DECROSSLINKING EXTRUSION

(71) Applicants: Kailong JIN, Phoenix, AZ (US); Timothy LONG, Phoenix, AZ (US); Jared NETTLES, Chandler, AZ (US)

(72) Inventors: Kailong JIN, Phoenix, AZ (US); Timothy LONG, Phoenix, AZ (US); Jared NETTLES, Chandler, AZ (US)

(73) Assignee: Arizona Board of Regents on Behalf of Arizona State University, Scottsdale, AZ (US)

(21) Appl. No.: 19/224,616

(22) Filed: May 30, 2025

Related U.S. Application Data
(60) Provisional application No. 63/654,839, filed on May 31, 2024.

(51) Int. Cl. C08J 11/26

(52) U.S. Cl. CPC C08J 11/26

(57) ABSTRACT

A method for recycling/upcycling polyurethane thermosets is disclosed. The method includes grinding crosslinked polyurethane thermosets into granules, feeding the granules and a small-molecule carbamate decrosslinker into a twin-screw extruder, and heating the mixture to a temperature between 150° C. and 220° C. The method further includes adding a catalyst to the mixture within the extruder, catalyzing carbamate exchange reactions within the extruder to decrosslink the polyurethane, and extruding the resulting material as a thermoplastic polyurethane. The small-molecule carbamate may be hydroxyethyl methacrylate (HEMA) N-phenyl carbamate. The catalyst may be dibutyltin dilaurate (DBTDL). The method may further include purifying the extruded thermoplastic polyurethane to remove residual catalysts and unreacted decrosslinkers. The granules may have an average particle diameter of 1.5 mm.

### RELATED APPLICATIONS

This application claims the benefit of U.S. provisional patent application 63/654,839, filed May 31, 2024 to Kailong Jin, et al., titled “METHOD FOR UPCYCLING POLYURETHANE THERMOSETS INTO THERMOPLASTICS VIA SMALL-MOLECULE CARBAMATE-ASSISTED DECROSSLINKING EXTRUSION,” the entirety of the disclosure of which is hereby incorporated by this reference.

### STATEMENT REGARDING FEDERALLY SPONSORED RESEARCH OR DEVELOPMENT

This invention was made with government support under 2132183 awarded by the National Science Foundation. The government has certain rights in the invention.

### TECHNICAL FIELD

This document relates to a method for upcycling thermosets into thermoplastics via small-molecule carbamate-assisted decrosslinking extrusion.

### BACKGROUND

Polyurethane (PU) materials play an essential role in modern manufacturing and consumer products due to their mechanical versatility, chemical tunability, and broad applicability across industries. PUs can be synthesized as either thermoplastic or thermoset polymers, with thermoset formulations being particularly prevalent in high-performance applications because of their superior dimensional stability, mechanical strength, and thermal resistance. These thermoset PUs are frequently used in construction, transportation, packaging, electronics, and consumer goods, with especially common implementations in the form of foams, elastomers, coatings, and adhesives.

However, the robust crosslinked network structure that impart desirable mechanical and thermal properties to thermoset PUs also presents significant challenges for end-of-life management. Unlike thermoplastics, which can be readily melted and reshaped, thermoset PUs cannot be reprocessed using conventional melt-processing techniques. Consequently, end-of-life PU thermosets are typically disposed of via landfilling or subjected to mechanical downcycling methods that convert them into lower-value materials, thus diminishing their utility and contributing to environmental burdens.

Various recycling strategies have been proposed to address the environmental and economic challenges posed by PU waste, including mechanical and chemical methods. While mechanical approaches may offer limited reuse of crosslinked PU waste, they generally result in lower structural integrity and quality. Chemical recycling methods, such as glycolysis and hydrolysis, can partially depolymerize PU networks to recover valuable intermediates, including polyols and oligomers. However, these chemical processes are often energy-intensive, reliant on the use of solvents, and inefficient for large-scale implementation. Moreover, they frequently yield recycled products with inferior mechanical and chemical properties compared to the original PU materials, limiting their applicability in high-performance applications.

### SUMMARY

The present disclosure relates to a method for recycling polyurethane thermosets, comprising grinding a crosslinked polyurethane thermoset into granules, feeding a mixture of the granules and a small-molecule carbamate decrosslinker into a twin-screw extruder, heating the mixture within the extruder to a temperature between 150° C. and 220° C., introducing a catalyst into the extruder, catalyzing carbamate exchange reactions within the extruder between the polyurethane thermoset and the decrosslinker, and extruding the mixture as a thermoplastic material.

Particular embodiments may comprise one or more of the following features. The small-molecule carbamate decrosslinker may be selected from the group consisting of stearyl N-phenyl carbamate, stearyl N-cyclohexyl carbamate, benzyl N-cyclohexyl carbamate, stearyl N-butyl carbamate, hydroxyethyl methacrylate N-phenyl carbamate, anthracenemethanol N-phenyl carbamate, and cinnamyl N-phenyl carbamate. The catalyst may be selected from the group consisting of dibutyltin dilaurate, zirconium (IV) acetylacetonate, and bismuth neodecanoate. The small-molecule carbamate decrosslinker may comprise a functional group selected from the group consisting of methacrylate, acrylate, epoxy, silane, anthracene, and stilbene. The method may further comprise purifying the thermoplastic material to remove residual catalyst and unreacted decrosslinker. The granules may have an average particle diameter of 1.5 millimeters.

The present disclosure relates to a method for recycling polyurethane thermosets, comprising feeding a mixture comprising a crosslinked polyurethane thermoset and a small-molecule carbamate decrosslinker into a twin-screw extruder, heating the mixture within the extruder to a temperature between 150° C. and 220° C., introducing a catalyst into the extruder, catalyzing carbamate exchange reactions between the polyurethane thermoset and the decrosslinker, and extruding the mixture as a thermoplastic material.

Particular embodiments may comprise one or more of the following features. The small-molecule carbamate decrosslinker may be selected from the group consisting of stearyl N-phenyl carbamate, stearyl N-cyclohexyl carbamate, benzyl N-cyclohexyl carbamate, stearyl N-butyl carbamate, hydroxyethyl methacrylate N-phenyl carbamate, anthracenemethanol N-phenyl carbamate, and cinnamyl N-phenyl carbamate. The catalyst may be selected from the group consisting of dibutyltin dilaurate, zirconium (IV) acetylacetonate, and bismuth neodecanoate. The small-molecule carbamate decrosslinker may comprise a functional group selected from the group consisting of methacrylate, acrylate, epoxy, silane, anthracene, and stilbene. The method may further comprise purifying the thermoplastic material to remove residual catalyst and unreacted decrosslinker. Catalyzing carbamate exchange reactions within the extruder may comprise breaking crosslinks in the polyurethane thermoset to form the thermoplastic material.

The present disclosure relates to a method for recycling polyurethane thermosets, comprising contacting a crosslinked polyurethane thermoset with a small-molecule carbamate decrosslinker to form a mixture, introducing a catalyst into the mixture, heating the mixture to a temperature sufficient to catalyze carbamate exchange reactions between the polyurethane thermoset and the decrosslinker, and recovering a decrosslinked polyurethane as a thermoplastic material.

Particular embodiments may comprise one or more of the following features. The thermoplastic material may be solvent-processable in a solvent selected from the group consisting of tetrahydrofuran (THF), dichloromethane (DCM), and acetone. The small-molecule carbamate decrosslinker may be selected from the group consisting of hydroxyethyl methacrylate N-phenyl carbamate, anthracenemethanol N-phenyl carbamate, and cinnamyl N-phenyl carbamate. The catalyst may comprise a Lewis acid suitable for catalyzing carbamate exchange reactions. The molecular weight or viscosity of the thermoplastic material may be controlled by the concentration of the small-molecule carbamate decrosslinker. The method may further comprise purifying the thermoplastic material to remove residual catalyst and unreacted decrosslinker. The temperature may be between 150° C. and 220° C. The mixture may be fed into a twin-screw extruder.

The present disclosure relates to a composition, comprising decrosslinked polyurethane chains derived from a crosslinked polyurethane thermoset, wherein the composition is melt-processable and solvent-soluble.

Particular embodiments may comprise one or more of the following features. The decrosslinked polyurethane chains may have a hydrodynamic diameter of from about 2 nm to about 10 nm. The composition may have a gel fraction of less than about 10 wt %. The composition may have a melt viscosity of less than about 100 Pa·s at 80° C. The decrosslinked polyurethane chains may comprise one or more chain-end functional groups selected from methacrylate, anthracene, stilbene, vinyl, allyl, or thiol. The composition may comprise polyurethane chains with a controlled molecular weight and chain-end functionality without requiring further purification.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements.

FIG. 1A illustrates a schematic diagram of an exemplary process for upcycling crosslinked polyurethane (PU) thermosets into functional PU thermoplastics through small-molecule carbamate-assisted decrosslinking extrusion according to some embodiments.

FIG. 1B illustrates an exemplary carbamate exchange reaction underlying the decrosslinking process according to some embodiments.

FIG. 2 presents a table of seven, non-limiting examples of small-molecule carbamates used as decrosslinkers in the contemplated method, including their molecular structures, melting points (Tm), and onset temperatures of volatilization/decomposition (Tv/d) according to some embodiments.

FIG. 3A shows the extruder's axial force and resulting extrudate gel fraction as functions of reaction time for a model PU film decrosslinking experiment according to some embodiments.

FIG. 3B presents dynamic light scattering (DLS) spectra of decrosslinked PU extrudates obtained at various reaction times according to some embodiments.

FIG. 3C shows the extruder's axial force and resulting extrudate gel fraction as functions of decrosslinker loading according to some embodiments.

FIG. 3D presents DLS spectra of decrosslinked PU extrudates obtained at various decrosslinker loadings according to some embodiments.

FIG. 4A illustrates DLS spectra of decrosslinked PU extrudates obtained using different small-molecule carbamate decrosslinkers according to some embodiments.

FIG. 4B presents FTIR spectra of decrosslinked PU extrudates after dialysis, highlighting characteristic peaks of carbamate linkages and functional groups according to some embodiments.

FIG. 5 shows a DLS spectrum of a dilute solution of decrosslinked PU extrudates from a decrosslinked PU foam according to some embodiments.

FIG. 6A depicts a schematic of a lap shear test assembly for measuring shear adhesion strength of decrosslinked PU extrudates according to some embodiments.

FIG. 6B presents lap shear adhesion strength data of decrosslinked PU extrudates at different decrosslinker loadings according to some embodiments.

FIG. 6C shows G′ vs. frequency data of decrosslinked PU extrudates at room temperature according to some embodiments.

FIG. 6D presents viscosity vs. shear rate data of decrosslinked PU extrudates at room temperature according to some embodiments.

FIG. 7A shows the evolution of G′ and G″ of a PU-methacrylate photoresin during UV curing according to some embodiments.

FIG. 7B presents FTIR spectra of the PU-methacrylate photoresin before and after UV curing, demonstrating the disappearance of methacrylate groups according to some embodiments.

FIG. 8A depicts a schematic of anthracene-functionalized PU chains undergoing dimerization and reversion according to some embodiments.

FIG. 8B presents FTIR spectra of anthracene-functionalized PU extrudates before and after UV irradiation, confirming anthracene dimerization according to some embodiments.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

Polyurethanes (PUs) are the sixth-largest class of manufactured consumer plastics, with a global market volume of approximately 56 billion pounds (roughly $87 billion market value) in 2023 and are projected to reach around 69 billion pounds (approximately $120 billion market value) by 2030. Due to their tunable material properties, PUs find widespread use across diverse applications ranging from CASE industries (Coatings, Adhesives, Sealants, and Elastomers) to PU foams (PUFs) for comfort and construction. In many applications, PUs are synthesized as crosslinked thermosets, which provide robust mechanical properties and thermal stability. However, their permanent network structures rend them unrecyclable via conventional melt processing techniques used for thermoplastics, resulting in a low end-of-life PU recycling rate of only approximately 5.5%.

Exiting PU recycling methods are predominantly mechanical, involving grinding crosslinked PUs into particles and combining them with binders to produce low-value products such as carpet underlayers. Chemical recycling approaches, such as glycolysis, typically involve the application of solvents, heat, and extended reaction times to cleave carbamate linkages (urethane bonds) and depolymerize the PU network into oligomers. These processes are followed by energy-intensive, multi-step separations to recover PU precursors (such as polyols), often yielding products of inferior quality and limited applicability compared to the original PUs. Consequently, there is a pressing need for more efficient, environmentally friendly recycling methods capable of upcycling PU waste into higher-value products.

Recent studies have explored alternative PU recycling strategies that convert static PU networks into thermally reprocessable, dynamic covalent adaptable networks (CANs). These approaches incorporate Lewis acid catalysts, such as dibutyltin dilaurate (DBTDL), either during the synthesis of new PUs or during reprocessing of post-consumer PUs. The catalysts promote dynamic carbamate exchange reactions at elevated temperatures (typically 180-220° C.), enabling the resulting PU CANs to be reshaped under stress via conventional melt-state processing such as compression molding and twin-screw extrusion, akin to many other CANs and vitrimers. At lower service temperatures, however, these PU CANs retain their network structures and thermomechanical properties similar to traditional PU thermosets.

Using this dynamic carbamate exchange-enabled approach, waste crosslinked PUs (e.g., PUFs) have been reprocessed into recycled PU films and filaments with equivalent network structures and properties. This has been demonstrated through a bulk (solvent-free), continuous twin-screw extrusion process. More recently, the approach has been extended to circular foam-to-foam recycling, combining twin-screw extrusion with foaming to convert original crosslinked PUFs into next-generation PUFs exhibiting comparable porous microstructures and compression properties.

Despite the advantages of this dynamic approach, including circularity, high energy/atom efficiency, and reprocessability, prior efforts have largely been constrained to thermoset-to-thermoset reprocessing of PU CANs. The inherent percolated network structures and associated high viscosities of PU CANs impose challenges for applications requiring low-viscosity liquid precursors, such as coatings, adhesives, and sealants.

To overcome these limitations, the present disclosure introduces a novel, efficient method for transforming crosslinked PU networks into value-added thermoplastic materials. This method employs a scalable, solvent-free decrosslinking process driven by small-molecule carbamate decrosslinkers and catalyzed carbamate exchange reactions. By enabling controlled deconstruction of PU thermosets under mild conditions using twin-screw extrusion technology, this approach provides a sustainable and economically viable pathway for managing PU waste. The following sections detail various embodiments and examples of this recycling/upcycling process, highlighting its versatility, efficiency, and potential for broad industrial applicability.

In particular, the disclosed method converts polyurethane thermosets into thermoplastics via small-molecule carbamate-assisted decrosslinking extrusion. This approach is scalable, modular, high-throughput, and solvent-free. Small-molecule carbamate decrosslinkers facilitate rapid decrosslinking of crosslinked PU thermosets during catalytic reactive extrusion, yielding a library of processable and functional thermoplastic PUs. According to various embodiments, the method contemplated herein accommodates a variety of decrosslinkers and PU forms, contributing significantly to sustainable plastic waste management and the circular economy.

During this process, whether executed as a one-step or a multi-step procedure, small-molecule carbamates undergo rapid, catalyzed carbamate exchange reactions with crosslinked PU feedstocks (e.g., films, foams, etc.) within the twin-screw extruder. These carbamates serve as end-capping reagents, rapidly decreasing crosslink density and ultimately deconstructing PU networks into low-viscosity, solution-processable decrosslinked PU chains.

Conventional chemical recycling methods for PU are slow and energy-intensive, often requiring at least four to six hours to break carbamate linkages. Unexpectedly, the contemplated method achieves substantial network deconstruction in approximately eight minutes, transforming high-gel fraction networks into low-gel fraction, mostly solvent-soluble materials.

Furthermore, conventional methods for reprocessing PU thermosets generally result in high-viscosity materials (i.e., other thermosets), limiting their applicability in formulations such as coatings, sealants, and adhesives. According to various embodiments, the disclosed method yields solvent-soluble thermoplastic materials with very low viscosity, which can be readily applied, including by spraying. In some embodiments, the viscosity of the repurposed PU may be tunable and can be tailored for specific uses and application in different forms.

The contemplated method is not only rapid but also produces consistent, predictable results despite the complexity of PU materials. For example, both the functionalization of PU chains and the resulting viscosities can be tuned in a reproducible manner.

Unlike conventional approaches, which merely convert one thermoset form into another, the process disclosed herein achieves transformation of crosslinked Pus into solvent-soluble thermoplastics. Thus, the thermoplastic may be soluble in a solvent such as tetrahydrofuran (THF), dichloromethane (DCM), and acetone. Additionally, the use of functionally designed small-molecule carbamate decrosslinkers allows for the installation of specific chain-end functionalities, enabling subsequent processing (e.g., methacrylate-functionalized PU chains for photocuring).

The disclosed method enables transformation of waste PU thermosets into a versatile library of thermoplastic PU feedstocks with controlled molecular weights and chain-end functionalities. These materials can be directly utilized without further purification in diverse applications including adhesives, photoresins for coatings and 3D printing, and stimuli-responsive materials. This process is particularly attractive for sustainable PU recycling/upcycling, considering its relatively mild reaction conditions, rapid reaction rates, compatibility with existing polymer processing equipment, and the highly modular structure-property-function relationships of the resulting products.

While the subsequent discussion focuses primarily on model PU films and foams fabricated for research purposes, the disclosed methods and systems may be adapted for post-consumer foams and other PU materials. Commercial Pus often contain various additives, including nano- to micron-sized particles as inert fillers within the PU network. Some embodiments of the disclosed method may be adapted to accommodate these additives.

Additionally, while the examples provided below focus on processing thermoset PU films, the disclosed methods may also be applicable to processing and functionalizing thermoplastic PU products, for example, in preparation for downstream applications such as photocuring or 3D printing. Moreover, these methods may be adapted to other step-growth polymer networks capable of undergoing catalytic bond exchange reactions, including crosslinked polyureas and polyesters, thereby contributing more broadly to plastic waste management.

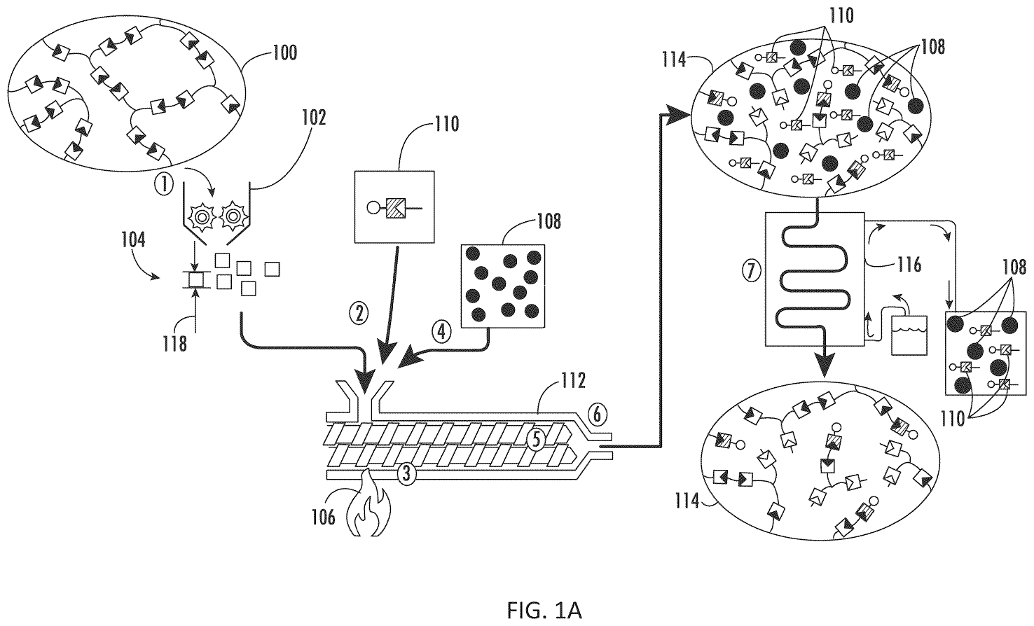

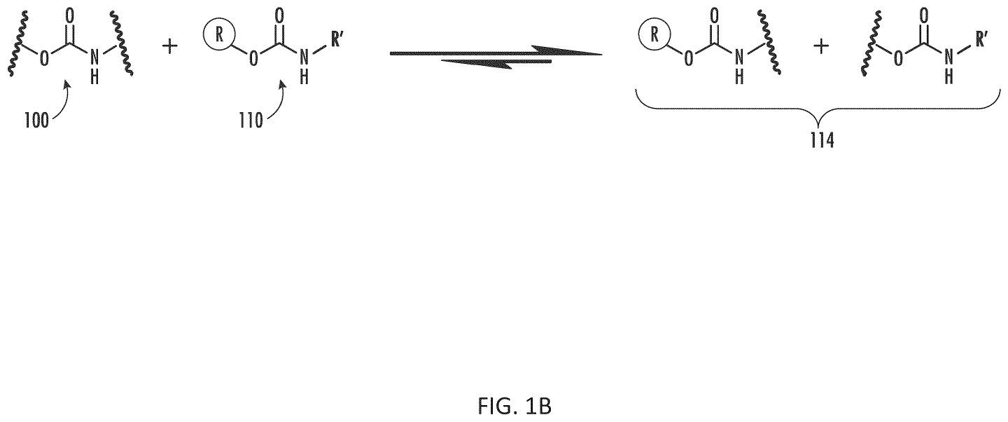

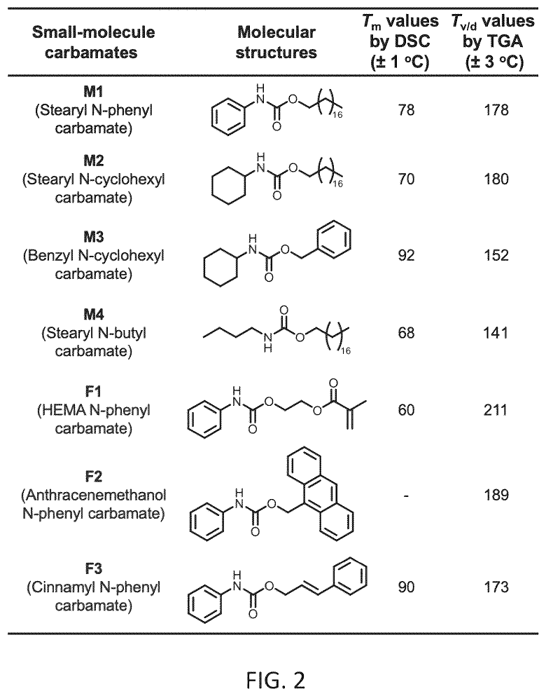

In some embodiments, the contemplated method relates to upcycling crosslinked polyurethane (PU) thermosets into functional PU thermoplastics through small-molecule carbamate-assisted decrosslinking extrusion, as shown in FIG. 1A and FIG. 1B. According to various embodiments, a small-molecule carbamate decrosslinker 110 undergoes catalytically facilitated carbamate exchange reactions with crosslinked PU thermosets 100 in a twin-screw extruder 112, producing decrosslinked (linear/branched) and functional PU chains suitable for value-added applications. Various examples of small-molecule carbamates, along with the functional groups they can install, are presented and discussed in further detail below in connection with FIG. 2.

In some embodiments, the method for recycling/upcycling crosslinked polyurethane thermosets into functional PU thermoplastics contemplated herein proceeds as follows. First, the crosslinked polyurethane thermosets 100 are prepared for processing in a twin-screw extruder 112, as indicated by circle 1 in FIG. 1A. According to various embodiments, this preparation involves grinding the crosslinked PU 100 into granules 104. A grinder 102 may be used for this purpose. In some embodiments, including specific examples discussed below, the granules 104 may have an average particle diameter 118 of approximately 1.5 mm. This size facilitates efficient feeding and mixing in the particular twin-screw extruder 112 used. In some embodiments, other diameters 118 may be implemented to accommodate the needs of other twin-screw extruders 112.

Next, the ground polyurethane granules 104 and small-molecule carbamate decrosslinkers 110 are introduced into the twin-screw extruder 112, as indicated by circle 2 in FIG. 1A. In some embodiments, the twin-screw extruder 112 comprises a feeding system designed to ensure a consistent and controlled flow of materials. As is known in the art, a twin-screw extruder 112 is equipped with screws designed to create a high-shear turbulent flow. This turbulent flow enhances the mixing and promotes the reaction between the polyurethane feedstock and the small-molecule carbamate decrosslinkers 110. While a twin-screw extruder 112 is described herein, other extrusion systems, continuous mixers, or batch processing systems capable of providing sufficient shear and mixing may also be employed.

In some embodiments, heat 106 is applied to heat the mixture to a temperature between 150° C. and 220° C., as indicated by circle 3 in FIG. 1A. In some embodiments, an optimal temperature may be approximately 165° C. This heating facilitates the catalytic carbamate exchange reactions necessary for decrosslinking. The temperature ranges provided herein are exemplary, and alternative temperatures or heating methods that achieve effective carbamate exchange reactions are contemplated.

A catalyst 108 is introduced to the twin-screw extruder 112 to accelerate the decrosslinking reactions, as indicated by circle 4 in FIG. 1A. As the mixture flows through the extruder 112 with its turbulent flow, as indicated by circle 5 in FIG. 1A, the small-molecule carbamate decrosslinkers 110 undergo catalytic exchange reactions with the crosslinked polyurethane 100. These reactions deconstruct the crosslinked networks, breaking the crosslinks in the polyurethane thermoset, reducing the material's viscosity and enabling its transformation into a thermoplastic. Exemplary catalysts include, but are not limited to, dibutyltin dilaurate (DBTDL), zirconium (IV) acetylacetonate, and bismuth neodecanoate. While the present disclosure emphasizes carbamate exchange reactions facilitated by Lewis acid catalysts, other dynamic exchange chemistries, including but not limited to ester, urea, or imine exchange, and other catalyst classes such as organocatalysts or enzyme-mediated systems, may be similarly employed within the scope of the invention.

After the reaction has taken place for an appropriate amount of time, the decrosslinked polyurethane is extruded as a thermoplastic material 114 as indicated by circle 6 in FIG. 1A. This material can be further purified to remove any residual catalysts 108 and unreacted decrosslinkers 110 as indicated by circle 7 of FIG. 1A, according to various embodiments. Any purification system or filter 116 may be used to purify the thermoplastic material 114.

According to various embodiments, the fundamental principle of this small-molecule carbamate-assisted PU decrosslinking method builds on the reverse of the classical Flory-Stockmayer “gelation” theory, which predicts the minimum level of branch unit incorporation or conversion to achieve a percolated network, i.e., gelation, during step-growth polymerization. Herein, any small-molecule carbamate decrosslinker (see, for example, FIG. 2) can be treated as a stoichiometric mixture of monofunctional alcohols and monofunctional isocyanates at full functional group conversion, while the model crosslinked PU film can be treated as a stoichiometric mixture of trifunctional alcohols (i.e., crosslinker or branch unit; functionality f=3) and difunctional isocyanates at full functional group conversion. The ratio between the added small-molecule carbamate decrosslinkers and the model crosslinked PU dictates the probability of a crosslinker leading to another crosslinker by a chain (a; also known as branching coefficient) in an equivalent polymerization mixture comprising equimolar monofunctional alcohols and isocyanates as well as stoichiometrically balanced trifunctional alcohols and difunctional isocyanates. In order for complete deconstruction of the originally crosslinked PU, i.e., no percolated network formation in the equivalent polymerization mixture, a must be smaller than the critical value for gelation, α_{c}, where α_{c}=1/(f−1)=0.5 in this study. Based on this simple analysis, the amount of small-molecule carbamate decrosslinkers required to deconstruct the model crosslinked PU is ˜30 mol % relative to the total amount of the carbamate linkages in the entire feed mixture.

It is noteworthy that this simple theoretical analysis is expected to overestimate the amount of small-molecule carbamate decrosslinkers required to deconstruct PU network. This is because the classical Flory-Stockmayer theory builds on simplified assumptions of equal functional group reactivities and ignores potential intramolecular reactions leading to loops that do not contribute to network formation.

FIG. 2 shows a table of seven, non-limiting examples of small-molecule carbamates used as decrosslinkers 110 within the contemplated method, and their molecular structures, melting points (Tₘ) measured by DSC, and onset temperatures of volatilization/decomposition (T_{v/d}) measured by TGA. It should be noted that although this is a limited set of examples, there are numerous other small-molecule carbamates that could be added; the collection of small-molecule carbamates could be described as a library. In addition, it is to be understood that the specific parameters, conditions, and proportions provided in the following examples are intended for illustrative purposes only and are not to be construed as limiting. Variations in scale, component concentrations, processing equipment, and reaction conditions are contemplated within the scope of the invention. The following specific examples are not intended to limit the scope of the disclosed methods. Other variations, substitutions, and equivalents consistent with the teachings herein are contemplated.

The exemplary small-molecule carbamates listed in FIG. 2 have each been synthesized; the resulting properties of many will be discussed below. Specifically, these seven small-molecule carbamates are stearyl N-phenyl carbamate (noted as M1), stearyl N-cyclohexyl carbamate (M2), benzyl N-cyclohexyl carbamate (M3), stearyl N-butyl carbamate (M4), hydroxyethyl methacrylate (HEMA) N-phenyl carbamate (F1), anthracenemethanol N-phenyl carbamate (F2), and cinnamyl N-phenyl carbamate (F3).

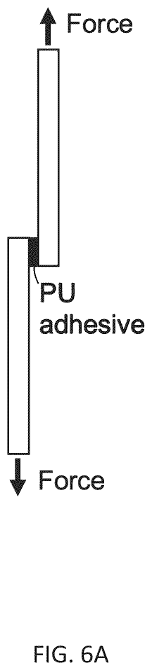

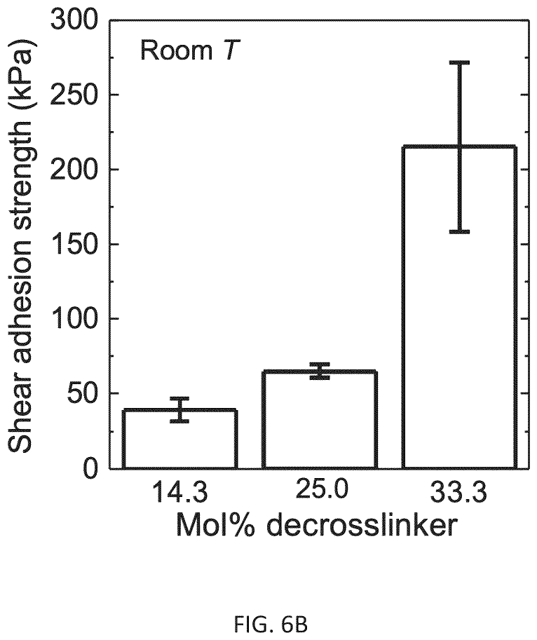

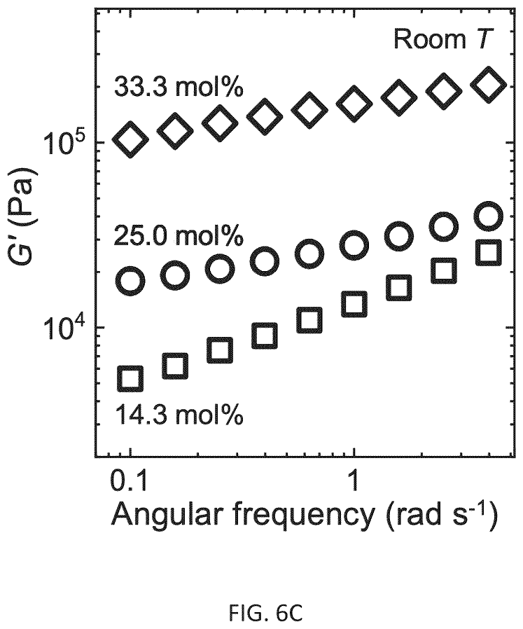

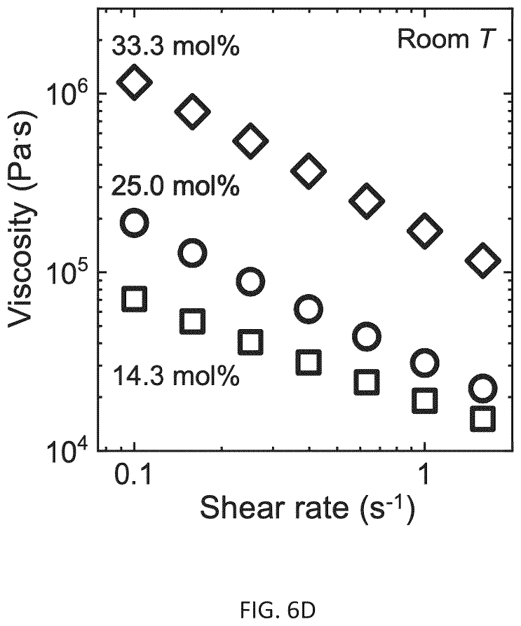

M1 serves as a model small-molecule carbamate decrosslinker 110 for establishing the catalytic decrosslinking extrusion process and studying key reaction parameters. M2, M3, and M4 were selected to study how small-molecule carbamates' steric and electronic structures affect the overall PU decrosslinking extrusion process, while F1, F2, and F3 are used to simultaneously incorporate chain-end functionalities including methacrylate, anthracene, and stilbene groups. F1-F3 will be discussed further in the context of FIGS. 6A-8B, below. Additionally, other functional groups capable of participating in downstream reactions or imparting desirable properties, such as acrylate, epoxy, silane, vinyl, allyl, thiol, or other photo- or thermo-reactive groups, may be incorporated into the small-molecule carbamate decrosslinkers.

All of the small-molecule carbamates in FIG. 2 (except M4) were synthesized in a similar manner by reacting monofunctional isocyanates with monofunctional alcohols (10 mol % excess). In a typical synthesis of the model small-molecule carbamate M1 in FIG. 2, stearyl alcohol (12.5 g, 46.2 mmol) is first dissolved in anhydrous tetrahydrofuran (THF; 100 mL) in a round bottom flask equipped with a magnetic stir bar, rubber septa, nitrogen inlet, and nitrogen outlet, which is held at 0° C. in an ice bath. Phenyl isocyanate (5.0 g, 42.0 mmol) and DBTDL (0.133 g, 0.21 mmol, 0.5 mol % of the total amount of isocyanate groups) are then added to the flask, and the resulting mixture is allowed to react for 2 h before precipitation into methanol (1000 mL). The precipitated products are collected by filtration and rinsed with 500 mL methanol, followed by vacuum drying at 40° C. for 6 hours to yield white crystalline solids at room temperature.

In a specific example, in one embodiment, all the small-molecule carbamates in FIG. 2 (except M4) were synthesized by reacting monofunctional isocyanates with monofunctional alcohols (10 mol % excess), followed by precipitation and drying. Notably, M4 was synthesized using carbonyl diimidazole in an isocyanate-free manner, demonstrating a more environmentally benign and potentially safer route to these small-molecule carbamate decrosslinkers. ¹H and ¹³C NMR as well as FTIR analyses of these synthesized small-molecule carbamates confirm their expected chemical structures as shown in FIG. 2. All these small-molecule carbamates are solids at room temperature and report melting points (Tₘ) between 60-92° C. (except F2), as measured by DSC. In addition, they report onset temperatures of volatilization/decomposition (noted as T_{v/d}) between 141-211° C., as measured by TGA.

As stated above, in the specific, non-limiting examples that will be discussed below, the crosslinked PU thermoset that was upcycled was in fact a model crosslinked PU film. The initial model crosslinked PU films were prepared by step-growth polymerization of a stoichiometric alcohol/isocyanate (—OH/—NCO) mixture of polyethylene glycol-based triol and 2,4-toluene diisocyanate (TDI) at room temperature under nitrogen atmosphere. Crosslinking of these model PU films is confirmed by their insolubility and swelling behavior in dichloromethane. Quantitative swelling tests of these model crosslinked PU films report a relatively high gel fraction of ˜95 wt %, in agreement with the nearly full consumption of —OH and —NCO groups after polymerization, as measured by FTIR. Consistently, rheological frequency sweep of these model PU films at room temperature reveals an elastic shear modulus (G′) plateau at low frequency, characteristic of a crosslinked elastic solid. In addition, these model crosslinked PU films report a glass transition temperature (T_{g}; measured by DSC) of ˜−30° C. and degradation temperature (Td; measured by TGA) of ˜280° C., respectively.

According to various embodiments, catalytic PU decrosslinking is carried out by feeding the dry, ground model crosslinked PU films (granules 104) (average particle diameter 118 of 1.6±0.4 mm as measured by scanning electron microscopy; SEM), together with the target small-molecule carbamate decrosslinkers 110 and DBTDL carbamate exchange catalysts 108, into a twin-screw extruder 112. The reactive extrusion temperature was held at 165±10° C. throughout this study, which is below the T_{v/d} values of the small-molecule carbamates in FIG. 2 (except M3 and M4) and DBTDL (>280° C.). It is noteworthy that all the small-molecule carbamates fed into the extruder exhibited no or negligible weight loss due to volatilization/decomposition during reactive extrusion in the tightly sealed extrusion chamber. It is also noteworthy that DBTDL can be replaced by lower-toxicity catalysts such as zirconium (IV) acetylacetonate [Zr(acac)₄], which have been recently demonstrated effective in enhancing carbamate exchange rates. As these model crosslinked PU film granules 104 are heated inside the twin-screw extruder 112, the reversible urethane dissociation and recombination enable the PU network to undergo deconstruction via catalyzed carbamate exchange reactions with the small-molecule carbamate decrosslinkers.

As a specific example, in one embodiment, a representative model PU film decrosslinking experiment using M1 (FIG. 2), dry model crosslinked PU films (3.500 g, containing 8.2 mmol of carbamate linkages) were ground and fed into a Xplore microcompounder (5 mL capacity, recirculated twin-screw extrusion design) held at 165±10° C., together with M1 (1.069 g, containing ˜2.74 mmol of carbamate linkages; 25.0 mol % of the total carbamate linkages in both small-molecule carbamate decrosslinkers and model crosslinked PU films) and DBTDL catalysts (0.277 g, 0.44 mmol, 4.0 mol % of the total carbamate linkages in the feed mixture). The feed materials were mixed at 150 rpm for 8 min under nitrogen atmosphere before extrusion, affording homogeneous, transparent, and low-viscosity liquid extrudates, light tan in color. The resulting extrudates were either used/characterized as extruded or after dialysis purification using cellulose tubing with a 3 kg mol⁻¹ molecular weight cut-off.

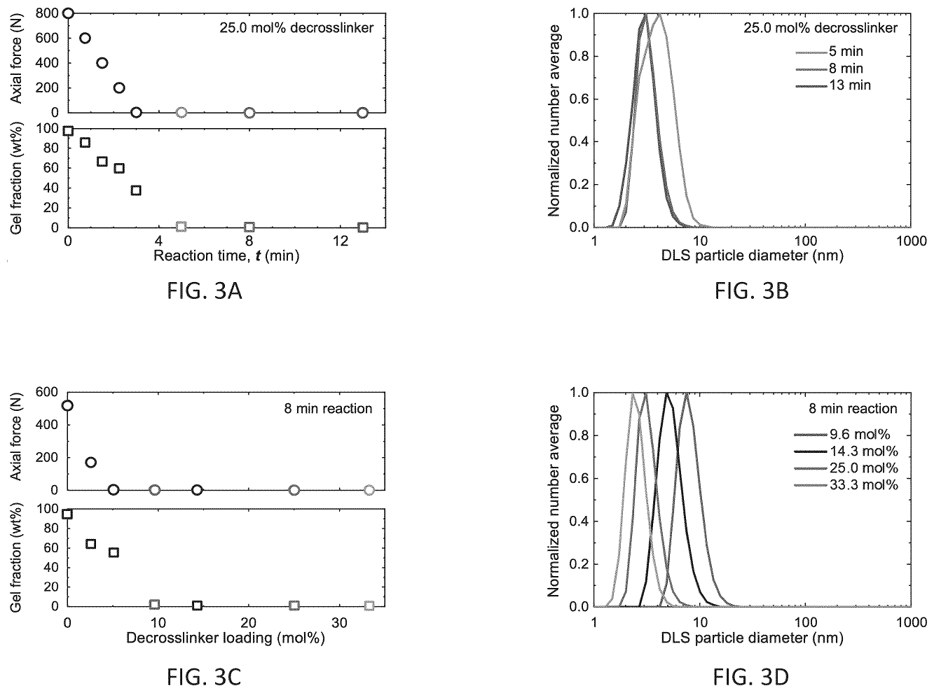

FIGS. 3A-3D illustrate aspects of the decrosslinking extrusion of a model crosslinked polyurethane (PU) film with a small-molecule carbamate decrosslinker (M1). Specifically, FIG. 3A shows the extruder's axial force and resulting extrudate's gel fraction as functions of reaction time t at 25.0 mol % M1 loading. FIG. 3B shows the DLS spectra of the decrosslinked extrudates obtained at t=5, 8, and 13 min in FIG. 3A. FIG. 3C shows the extruder's axial force and resulting extrudate's gel fraction as functions of M1 loading at t=8 min. FIG. 3D shows the DLS spectra of the decrosslinked extrudates obtained with 9.6, 14.3, 25.0, and 33.3 mol % M1 in FIG. 3C. The experimental errors in FIGS. 3A and 3C are standard deviations from three measurements, which are smaller than the symbol sizes.

A specific, non-limiting example of decrosslinking extrusion using the contemplated method focused on a model system comprising 3.500 g model crosslinked PU films (8.2 mmol of carbamate linkages), 1.069 g model small-molecule carbamates M1 (˜2.74 mmol of carbamate linkages; 25.0 mol % of the total number of carbamate linkages in the feed mixture, greater than the required decrosslinker amount predicted above), and 0.277 g DBTDL catalysts (4.0 mol % of the total number of carbamate linkages). FIG. 3A (top) plots the evolution of the extruder's axial force, a measure of the reaction mixture's viscosity, with increasing mixing time t, which decreases steadily from ˜800 N at t=0 min to ˜0 N at t≈3 min. In contrast, the same mixture without the incorporation of DBTDL exhibits a nearly unchanged axial force at˜800 N over time under the same mixing conditions, indicating that carbamate exchange catalysts are indeed required to catalyze the reactions between crosslinked PU and small-molecule carbamate decrosslinkers.

Qualitatively consistent with the decreasing trend of the extruder's axial force with increasing t, the corresponding PU extrudates obtained after catalytic extrusion appear as heterogeneous, light tan-colored solids at shorter t, but they transform into homogeneous, transparent, and viscous liquids, light tan in color, at longer t. Quantitatively, FIG. 3A (bottom) plots the t-dependent gel fraction of the resulting extrudates, which decreases from ˜95 wt % at t=0 min to ˜0 wt % at t=5 min. This indicates the complete deconstruction of crosslinked PU networks at or after t=5 min into decrosslinked (linear or branched) PU chains that are completely soluble in THF. Consistently, a rheological frequency sweep of the extrudates obtained after reacting for 8 min confirms complete PU network deconstruction, i.e., their G′ and G″ moduli at 80° C. (where the hydrogen bonding between carbamate linkages is relatively weak) exhibit liquid-like scaling at low frequency. Notably, the FTIR spectra of the resulting decrosslinked extrudates resemble those of initial feed mixtures, both showing characteristic peaks for urethane linkages and no evidence for new chemical bond formation. This is consistent with PU network deconstruction mechanism/process through catalyzed carbamate exchange reactions with small-molecule carbamate decrosslinkers.

FIG. 3B compiles the corresponding dynamic light scattering (DLS) spectra for dilute THF solutions of the decrosslinked PU extrudates in FIG. 3A. According to FIG. 3B, these extrudates' hydrodynamic diameter (Dₕ) distribution curves shift to smaller sizes and become narrower with increasing t. Specifically, the Dₕ distribution at t=5 min appears relatively broad spanning from ˜2 to ˜12 nm, then becomes narrower ranging from ˜2 to ˜8 nm after reacting for 8 and 13 min. Correspondingly, the peak Dₕ values initially decrease from ˜4 nm at t=5 min to ˜3 nm at t=8 min, then remain nearly unchanged at t=13 min. Dₕ can be positively correlated to decrosslinked PU's molecular weight. For example, a decrosslinked PU chain of Dₕ being 5 nm roughly corresponds to a molecular weight of ˜3 kg mol⁻¹, assuming it is a linear PU chain dissolved in a good solvent at a dilute concentration. However, this is expected to underestimate the actual molecular weight of decrosslinked PU extrudates, which probably possess branched architectures and intramolecular hydrogen bonding interactions. Considering these molecular/structural complications, size exclusion chromatography was not used for molecular weight determination in this study. Overall, DLS indicates that the decrosslinked PU extrudate's molecular weight and its distribution (i.e., width of the Dₕ distribution) continue to evolve until t˜8 min, at which the catalyzed carbamate exchange reactions in this system likely have reached an equilibrium state. Specifically, the decrosslinked polyurethane chains exhibit a hydrodynamic diameter ranging from about 2 nm to about 10 nm, as determined by dynamic light scattering (DLS) measurements. This size range corresponds to the formation of soluble, low-molecular-weight polyurethane chains capable of downstream processing. The weight-average molecular weight (Mw) of the decrosslinked polyurethane chains ranges from about 1,000 to about 100,000 g/mol, as determined from hydrodynamic diameter analysis and corresponding relationships with polymer molecular weight in dilute solutions.

According to various embodiments, this small-molecule carbamate-assisted PU decrosslinking process is highly modular. For example, while keeping other process parameters constant, (i.e., catalyst loading=4.0 mol %, T=165±10° C., and t=8 min), increasing the loading of model small-molecule carbamates M1 from 2.6 to 9.6 mol % leads to respective decreases in the extruder's axial force from ˜170 to ˜0 N and the gel fraction of the resulting PU extrudates from ˜64 to ˜0 wt % (see FIG. 3C). As expected, the experimental critical loading of small-molecule carbamate decrosslinkers at which crosslinked PU fully deconstructs (˜10 mol %, when the resulting extrudates' gel fraction drops to ˜0 wt %) is much lower than that predicted by the previously discussed simple Flory-Stockmayer-like analysis (˜30 mol %). The gel fraction of the resulting decrosslinked polyurethane extrudates is less than about 10 wt %, indicating near-complete deconstruction of the original crosslinked network.

Further increasing the M1 loading from 9.6 to 33.3 mol % leads to a consistent reduction in the resulting decrosslinked PU extrudates' molecular weight, according to their DLS characterizations in FIG. 3D. As a result, the final material properties of these decrosslinked PU extrudates, including T_{g}, rheological properties, and adhesion strength, can be systematically tuned over a wide range. For example, the decrosslinked PU extrudates' zero-shear melt viscosities at 80° C. decrease from ˜20 Pa s at 14.3 mol % M1 loading to ˜2 Pas at 33.3 mol % M1 loading, consistent with the well-established relationship between molecular weight and melt viscosity. The melt viscosity of the decrosslinked polyurethane extrudates at 80° C. is less than about 100 Pa·s, providing excellent processability by conventional polymer processing methods, including extrusion, injection molding, and spray application.

Accordingly, the decrosslinked polyurethane compositions produced using the disclosed methods exhibit unique and desirable properties, including a weight-average molecular weight (Mw) ranging from about 1,000 to about 100,000 g/mol, a hydrodynamic diameter (Dₕ) of about 2 nm to about 10 nm, a gel fraction of less than about 10 wt %, and a melt viscosity of less than about 100 Pas at 80° C. These properties highlight the transformation of crosslinked polyurethane thermosets into functional, processable, and low-viscosity thermoplastic materials suitable for a variety of high-value applications.

Continuing with the series of specific, non-limiting examples, the model PU network deconstruction process discussed above was applied to the other exemplary small-molecule carbonates of FIG. 2, to demonstrate the versatility/generalizability of the contemplated decrosslinking extrusion process.

In a specific, non-limiting example, the contemplated method was used to decrosslink the same model crosslinked PU films discussed above while using the other small-molecule carbamate decrosslinkers listed in FIG. 2, and while keeping the rest of the reactive extrusion conditions the same (i.e., decrosslinker loading=25.0 mol %, DBTDL loading=4.0 mol %, T=165±10° C., and t=8 min).

A notable small-molecule carbamate decrosslinker among this exemplary, non-limiting collection is F1, which contains a reactive methacrylate group. When F1 was employed as a decrosslinker, an excess amount of butylated hydroxytoluene (BHT; molar ratio between BHT and methacrylate groups=1.6:1) intentionally introduced to completely suppress any unwanted methacrylate chain-growth homopolymerization during reactive extrusion.

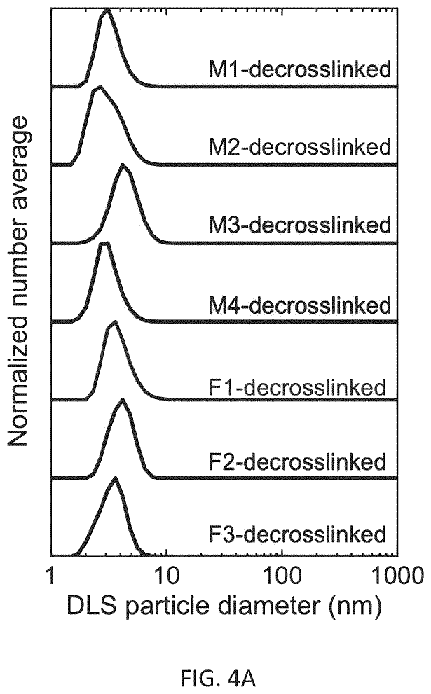

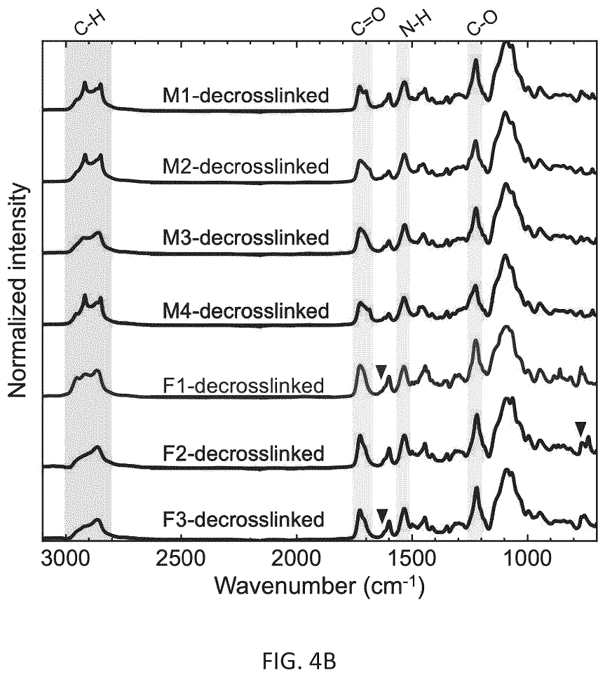

FIGS. 4A-4B show properties of non-limiting examples of decrosslinking extrusion of model crosslinked PU films in conjunction with the small-molecule carbamate decrosslinkers of FIG. 2. Specifically, FIG. 4A shows the DLS spectra of the decrosslinked extrudates obtained right after extrusion using the small-molecule carbamate decrosslinkers M1-4 and F1-3 at t=8 min. FIG. 4B shows the FTIR spectra of these decrosslinked extrudates after dialysis. The shaded regions in FIG. 4B highlight the characteristic peaks for carbamate linkages and different chain ends from M1-4 and F1-3. The triangles in FIG. 4B point at the characteristic peaks for methacrylate, anthracene, and stilbene groups.

All of the resulting PU extrudates after the decrosslinking reactions appear as homogeneous and transparent liquids at extrusion temperature, exhibiting no or negligible (e.g., <1 wt %) gel fraction, regardless of the small-molecule carbamate decrosslinkers used. Consistently, rheological frequency sweep experiments on these extrudates confirm their decrosslinked structures. The DLS spectra of all these as-obtained decrosslinked PU extrudates in FIG. 4A show Dₕ distributions with peak values varying from ˜2.7 to ˜4.2 nm, indicating that the small-molecule carbamate's steric/chemical structure and/or functionality may slightly impact the carbamate exchange decrosslinking reaction characteristics.

FIG. 4B compiles the FTIR spectra of these decrosslinked PU extrudates after dialysis to remove any residual small-molecule carbamates, DBTDL catalysts, and other species like BHT. As shown in FIG. 4B, all these decrosslinked PU extrudates show nearly identical characteristic peaks for carbamate linkages, e.g., ˜1720 cm⁻¹ for C═O stretch, ˜1535 cm⁻¹ for N—H bend, and ˜1220 cm⁻¹ for C—O stretch, respectively.

In addition, change in the molecular structures of carbamate decrosslinkers (M1-4 and F1-3) leads to notably different FTIR signals in specific wavenumber ranges, which arise from individual carbamate decrosslinkers, in the resulting decrosslinked extrudates. For example, the aliphatic M4-decrosslinked extrudate exhibits much sharper sp³ C—H stretch peaks in the wavenumber range between 2925-2845 cm⁻¹ than those of the highly aromatic F2-decrosslinked extrudate (see FIG. 4B). Thus, the FTIR results indicate that these small-molecule carbamate decrosslinkers undergo exchange reactions with the originally crosslinked PU, serving as capping reagents that modify the chain ends of decrosslinked PU extrudates. Notably, a closer look at the FTIR in FIG. 4B confirms the successful installation of various reactive functional groups onto decrosslinked PU chains, i.e., methacrylate group from F1, anthracene group from F2, and stilbene group from F3. Consistently, NMR characterizations of all these decrosslinked PU extrudates after dialysis confirm the carbamate exchange reactions between crosslinked PU and small-molecule decrosslinkers.

Overall, it is demonstrated above that the contemplated catalytic PU decrosslinking extrusion approach can generalize to a wide range of small-molecule carbamate decrosslinkers having various steric/electronic structures and reactive/functional moieties. This paves the way for upcycling post-consumer crosslinked PU thermosets into functional PU thermoplastics for potential value-added applications.

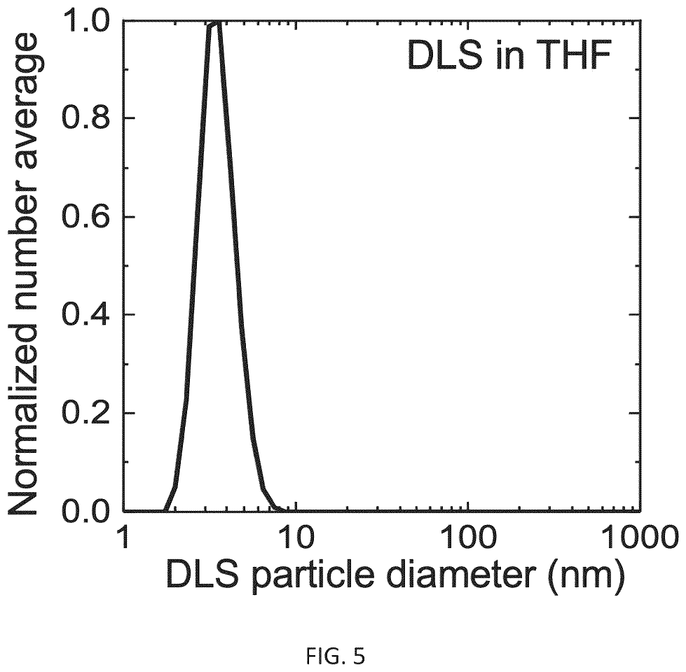

Continuing this specific, non-limiting example, the approach was extended to decrosslink a model crosslinked PU foam. FIG. 5 shows non-limiting examples of this specific embodiment applied to a model crosslinked PU foam. Specifically, FIG. 5 shows the DLS spectrum of a dilute solution of the resulting M1-decrosslinked extrudate in THF.

PU foams are of interest because they comprise ˜70% of the entire PU market. Herein, model crosslinked PU foams were synthesized by step-growth polymerization of a slightly off-stoichiometric mixture of the same triol and TDI previously discussed (—OH:—NCO=1:1.05) in the presence of catalytic amounts of DBTDL (0.5 mol % of the total-OH groups) and H₂O (30 mol % of the total-OH groups) as a chemical blowing agent. In addition to the —OH/—NCO reactions between triol and TDI, H₂O reacts with isocyanate to form carbamic acid, which then decarboxylates to produce a primary amine while releasing gaseous CO₂ to trigger the subsequent foaming process. These amines can further react with isocyanate groups to produce urea linkages in the synthesized model PU foam. According to SEM characterizations, the synthesized model PU foams show a semi-open cell geometry with an average cell diameter of 550±130 μm. In addition, swelling tests on this model PU foam confirm its crosslinking nature and report a relatively high gel fraction of ˜96 wt %, consistent with the nearly full functional group conversion measured by FTIR. This model crosslinked PU foam reports a T_{g} of ˜−26° C. by DSC, slightly higher than that of the model crosslinked PU film. In addition, it reports a Ta of ˜275° C. by TGA, nearly identical to that of the model crosslinked PU film.

Similarly, complete network deconstruction of this model crosslinked PU foam was achieved by reactive extrusion of the ground foams (average particle diameter of 1.4±0.7 mm; measured by SEM) in the presence of 25.0 mol % M1 under nearly identical reaction conditions (i.e., DBTDL loading=4.0 mol %, T=165±10° C., and t=8 min). The resulting decrosslinked extrudate is soluble in THF, whose DLS spectrum reports a Dₕ distribution with a peak centered at˜3.6 nm (see FIG. 5). Consistently, rheological frequency sweep experiments and FTIR/NMR analyses on the resulting extrudates confirm the complete network deconstruction of this model crosslinked PU foam after small-molecule carbamate-assisted decrosslinking extrusion.

Overall, these results demonstrate that the contemplated method for catalytic PU decrosslinking extrusion can be extended from crosslinked PU films to PU foams that have additional porous structures and polyurea microdomains, without sacrificing the decrosslinking efficiency of this dynamic carbamate exchange-based approach. According to various embodiments, this is a viable route to recycle/upcycle post-consumer/waste crosslinked PU foams in a solvent-free and relatively high-throughput manner.

As previously discussed, the contemplated small-molecule carbamate-assisted decrosslinking extrusion method can simultaneously deconstruct PU networks and functionalize the resulting decrosslinked PU chains. Advantageous over conventional recycling methods constrained to low viscosity thermoset products, the contemplated method can upcycle waste crosslinked PUs into readily processable/soluble and functionalized PUs towards high-end specialty applications, such as photocurable liquid PU resins that can be used for conformal coatings and vat photopolymerization-based additive manufacturing (i.e., 3D printing). The following is a discussion of three non-limiting examples of applications of these decrosslinked and functionalized PU products, specifically, adhesives, photoresins, and stimuli-responsive materials, with an emphasis on their structure-property-function relationships.

FIGS. 6A-6D illustrate the adhesion properties of a non-limiting example of the decrosslinked PU extrudates produced with the contemplated method. Specifically, FIG. 6A shows a lap shear test assembly for measuring the shear adhesion strength of decrosslinked PU extrudates. FIG. 6B shows room-temperature lap shear adhesion strength of the M1-decrosslinked model PU film extrudates obtained at various decrosslinker loadings. FIG. 6C shows room-temperature G′ vs. frequency and FIG. 6D shows room-temperature viscosity vs. shear rate dependences for the decrosslinked PU extrudates in FIG. 6B. The error bars in FIG. 6B are standard deviations from five measurements.

Polyurethanes offer good adhesion with a wide range of substrates, including metals, plastics, wood, glass, and ceramics, mainly due to the strong hydrogen bonding capabilities of the polar sites on their carbamate linkages. For adhesive application demonstration, the M1-decrosslinked PU film extrudates obtained at various decrosslinker loadings were selected for adhesion tests. Specifically, these as-obtained model M1-decrosslinked PU extrudates, without any additional purification/formulation, were directly sandwiched between two fresh microscope glass slides to form the assembly shown in FIG. 6A. Their room-temperature lap shear adhesion properties were tested by a tensile tester at a rate of 5 mm min⁻¹, and the measured lap shear strength values are plotted in FIG. 6B.

According to FIG. 6B, the lap shear adhesion strength of M1-decrosslinked PU film extrudates increases from ˜39 to ˜215 kPa as the M1 loading increases from 14.3 to 33.3 mol %. This increase can be attributed to a larger concentration of carbamate linkages capable of hydrogen bonding in the decrosslinked PU extrudate obtained at a higher M1 loading, thus enhancing its lap shear adhesion strength. One evidence for this is that these PU extrudates' G′ (see FIG. 6C) and viscosity (see FIG. 6D) at room temperature (where the hydrogen bonding between carbamate linkages is relatively strong) increase with increasing M1 loading, although decrosslinked PU's molecular weight and thus melt viscosity at 80° C. decrease with increasing M1 loading as already discussed. Overall, these results demonstrate that the adhesion performance of these decrosslinked PU extrudates can be systematically controlled by simply varying the loading of small-molecule carbamate decrosslinkers.

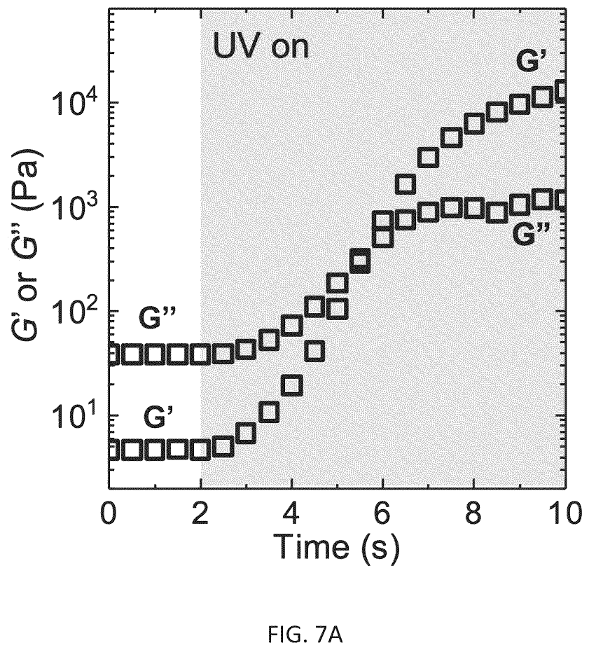

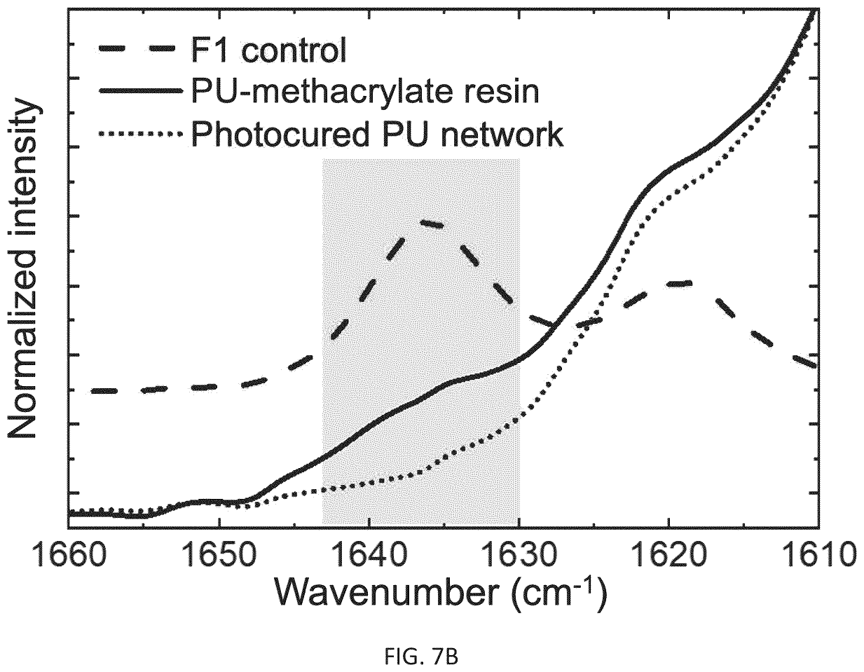

FIGS. 7A-7B show a non-limiting example of a PU-methacrylate liquid photoresin that undergoes UV curing at room temperature to form a crosslinked PU-methacrylate network solid film. Specifically, FIG. 7A shows the evolution of G′ and G″ of this PU-methacrylate photoresin during UV curing, where UV light is turned on 2 seconds into the rheological run and G′ and G″ cross over after ˜4 seconds of UV irradiation. FIG. 7B shows the FTIR spectra of this PU-methacrylate photoresin before and after UV curing, together with a F1 control spectrum to demonstrate the disappearance of the methacrylate groups in the PU-methacrylate photoresin after UV curing.

As mentioned above, methacrylate groups can be covalently attached onto the decrosslinked PU extrudates using the contemplated platform decrosslinking extrusion approach, which can serve as reactive moieties for subsequent thermal or photochemical curing processes. For photoresin application demonstration, the methacrylate-functionalized PU extrudates after dialysis were combined with 3 wt % radical photoinitiators, and the resulting mixture was cured at room temperature under ultraviolet (UV) light irradiation at an intensity of 9.8 mW cm⁻². Promisingly, this PU-methacrylate photoresin exhibits relatively fast curing kinetics, reporting a crossover of G′ and G″ (also known as the gel point) after ˜4 seconds of UV light irradiation (FIG. 7A). After photocuring for 15 s at room temperature, the characteristic FTIR peak of the methacrylate group in the F1-decrosslinked PU extrudate nearly disappeared due to methacrylate homopolymerization (FIG. 7B). As a result, the liquid PU-methacrylate photoresin transforms into a crosslinked solid, reporting a gel fraction of ˜90 wt %. In addition, these photocured samples report increased T_{g} and Ta values after methacrylate homopolymerization. Notably, these photocured PU-methacrylate networks comprise >90 wt % of PU segments and should be able to undergo stress relaxation or self-healing through dynamic topological rearrangement/reconfiguration among PU segments in the presence of carbamate exchange catalysts.

Overall, these results demonstrate that the contemplated PU network decrosslinking extrusion method can produce reactive (meth)acrylate-functionalized PU thermoplastics that can hold promise for applications including coating, packaging, and 3D printing.

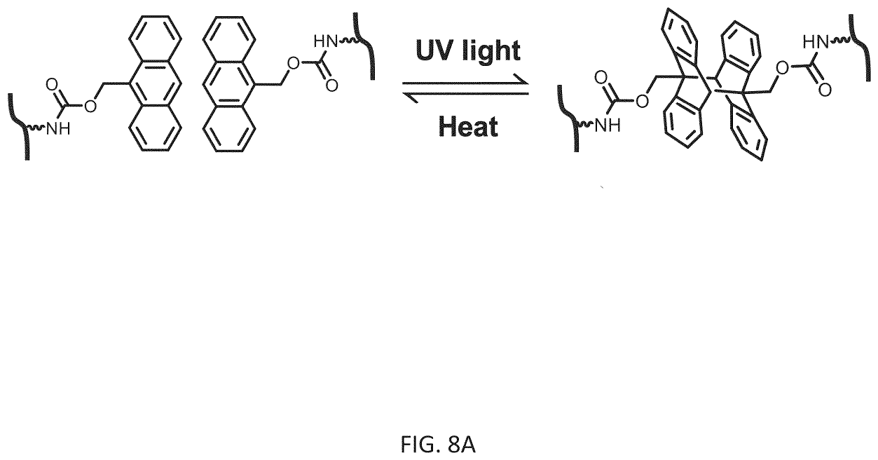

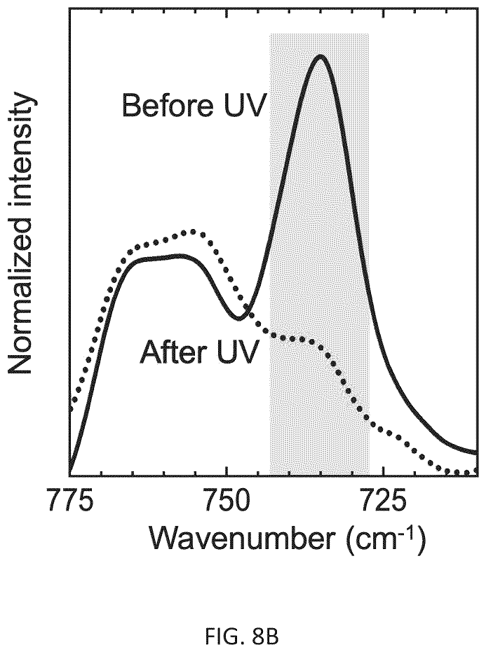

FIGS. 8A-8B illustrate the stimuli-responsive properties of non-limiting examples of anthracene-functionalized PU extrudates. Specifically, FIG. 8A shows a scheme showing that anthracene-functionalized chains can undergo dimerization under low-energy UV light irradiation to form anthracene-dimer linkages between chains, which are able to revert to free anthracene groups upon heating or high-energy UV light irradiation. FIG. 8B shows a FTIR spectra of this PU-anthracene extrudate before and after UV irradiation, demonstrating anthracene dimerization.

According to various embodiments, the contemplated catalytic PU decrosslinking extrusion approach can lead to PU chains functionalized with anthracene and stilbene groups, both of which are highly attractive in the field of stimuli-responsive materials. For example, anthracene groups are known to undergo efficient [4±4]-cycloaddition under low-energy UV light (λ>300 nm) irradiation, forming anthracene-dimers that can reversibly cleave into free anthracenes, by either high-energy UV light (2<300 nm) irradiation or high-temperature annealing (FIG. 8A). For demonstration, the anthracene-functionalized PU extrudates after dialysis were irradiated with λ>300 nm UV light at an intensity of 1.8 W cm⁻². After photocuring for ˜1 hour, the anthracene groups in the F2-decrosslinked PU extrudate report a conversion of ˜90%, as measured by FTIR (FIG. 8B). As a result of photo-dimerization, this anthracene-functionalized PU transitions from a liquid to an insoluble crosslinked solid reporting a gel fraction of ˜95 wt %. Similarly, the photocured sample reports an increased T_{g} after anthracene dimerization. Importantly, the formed anthracene-dimer linkages can reversibly cleave and revert to free anthracene groups after heating above ˜200° C.

Overall, these results demonstrate that the contemplated platform decrosslinking extrusion approach can enable upcycling of crosslinked PU networks into functional thermoplastic PUs comprising various stimuli-responsive groups, which can be subsequently used for fabricating self-healing materials or dynamic CANs.

The following are specific, non-limiting examples of various aspects of the contemplated method, in application. In some embodiments, the twin screw extrusion was performed using a Xplore MC 5 micro compounder (5 mL capacity) with corotating screws. Decrosslinking was performed at 165±10° C. with N₂ purge at 150 RPM. PU film and foam samples were first ground using a coffee grinder. Ground PU, decrosslinker, and catalyst were hand mixed, then fed into the hopper, and pushed into the barrel. Normal axial force measurements were reported by the instrument's software and recorded as displayed.

As a specific, non-limiting example of the dialysis of decrosslinked extrudate, in one embodiment, and for some characterizations/experiments, the decrosslinked PU extrudates were purified via dialysis using regenerated cellulose tubing with a 3 kg mol⁻¹ molecular weight cut-off. In a typical dialysis experiment, ˜1 g of decrosslinked PU extrudates were dissolved in 25 mL of anhydrous DCM and placed inside a dialysis tube. The tube was then sealed and submerged in 1 L of fresh anhydrous DCM in a 1 L glass beaker equipped with a star bar. The solution was covered with aluminum foil and allowed to stir for 24 hours, after which the solution outside the dialysis tube was replaced with fresh DCM. Three serial dilutions were performed on each decrosslinked PU extrudate, and the final dialyzed solution was subjected to rotary evaporation and then vacuum dried at room temperature for overnight.

As a specific, non-limiting example of the methacrylate-photoresin preparation, in one embodiment, methacrylate-functionalized PU extrudate after dialysis treatment was combined with 3 wt % Omnirad 2100 photoinitiators. Acetone was introduced to the sample to enable homogeneous mixing, then extracted via rotary evaporation and subsequent vacuum drying at room temperature. The resulting photoresin was homogeneous and tan in color.

As a specific, non-limiting example of the anthracene-photoresin curing, in one embodiment, anthracene-functionalized PU extrudate after dialysis treatment was directly placed between two glass slides with a thickness of 54 μm. The sample was irradiated with 250-450 nm light for 30 minutes per side at an intensity of 1.8 W cm⁻² at room temperature.

As a specific, non-limiting example of the synthesis of small-molecule carbamate decrosslinker M1, in one embodiment, stearyl alcohol (12.500 g, 0.046180 mol, 1.1 equiv.) was added to a 100 mL flame-dried round bottom flask equipped with a magnetic stir bar, nitrogen inlet, nitrogen outlet, and rubber septa, which was conditioned in an ice bath. Anhydrous THF (80 mL) was added to the flask to dissolve the solid stearyl alcohol. Phenyl isocyanate (5.000 g, 0.0420 mol, 1.0 equiv.) was added to the flask via syringe. Finally, DBTDL (0.133 g, 0.000210 mol, 0.005 equiv.) was added to the mixture, which was left to react under stirring and nitrogen flow for 2 hours. The reacted mixture was poured into cold methanol (1 L) to precipitate the solid product before isolation via vacuum filtration. The collected product was washed with additional methanol (500 mL) and then dried in a vacuum oven at 40° C. and ˜25 in-Hg for 6 hours, yielding a white powder (namely stearyl N-phenyl carbamate, M1).

As a specific, non-limiting example of the synthesis of small-molecule urethane decrosslinker M2, in one embodiment, stearyl alcohol (11.892 g, 0.043965 mol, 1.1 equiv.) was added to a 100 mL flame-dried round bottom flask equipped with a magnetic stir bar, nitrogen inlet, nitrogen outlet, and rubber septa, which was conditioned over an ice bath. Anhydrous THF (80 mL) was added to the flask to dissolve the solid stearyl alcohol. Cyclohexyl isocyanate (5.000 g, 0.03997 mol, 1.0 equiv.) was added to the flask via syringe. DBTDL (0.126 g, 0.000200 mol, 0.005 equiv.) was added to the mixture, which was left to react under stirring and nitrogen flow for 2 hours. The reacted mixture was poured into cold methanol (1 L) to precipitate the solid product before isolation via vacuum filtration. The collected product was washed with additional methanol (500 mL) and then dried in a vacuum oven at 40° C. and ˜25 in-Hg for 6 hours, yielding a white powder (namely stearyl N-cyclohexyl carbamate, M2).

As a specific, non-limiting example of the synthesis of small-molecule urethane decrosslinker M3, in one embodiment, benzyl alcohol (4.754 g, 0.04397 mol, 1.1 equiv.) was added to a 100 mL flame-dried round bottom flask equipped with a magnetic stir bar, nitrogen inlet, nitrogen outlet, and rubber septa conditioned in an ice bath. Anhydrous DCM (80 mL) was added to the flask. Cyclohexyl isocyanate (5.000 g, 0.03997 mol, 1.0 equiv.) was added to the flask via syringe. Then, DBTDL (0.126 g, 0.000200 mol, 0.005 equiv.) was added to the mixture, which was left to react under stirring and nitrogen flow for 2 hours. The reacted mixture was poured into cold hexanes (1 L) to precipitate the product before isolation via vacuum filtration. The collected product was washed with additional hexanes (500 mL) and then dried in a vacuum oven at 40° C. and ˜25 in-Hg for 6 hours, yielding a white powder (namely benzyl N-phenyl carbamate, M3).

As a specific, non-limiting example of the synthesis of small-molecule urethane decrosslinker M4, in one embodiment, step 1 comprises stearyl alcohol (8.672 g, 0.03206 mol, 1.3 equiv.) was added to a 100 mL flame-dried round bottom flask equipped with a magnetic stir bar, nitrogen inlet, nitrogen outlet, and rubber septa. Ethyl acetate (EtAc, 50 mL) was added to the flask to dissolve the stearyl alcohol. Carbonyl diimidazole (4.000 g, 0.02466 mol, 1.0 equiv.) was added to the flask, and the mixture was left to react for 4 hours. Step 1's product (stearyl carbonyl imidazolide) readily precipitated out of solution, which was isolated by filtration and dried in a vacuum oven at 40° C. and ˜25 in-Hg for 6 hours. Step 2. comprises the stearyl carbonyl imidazolide obtained from Step 1 (5.000 g, 0.01371 mol, 1.0 equiv.) was added to a flame-dried round bottom flask equipped with a magnetic stir bar, nitrogen inlet, nitrogen outlet, and rubber septa. Anhydrous THF (50 mL) was added to the flask to dissolve the stearyl carbonyl imidazolide. Butyl amine (1.500 g, 0.02057 mol, 1.5 equiv.) was then added to the flask via syringe, and the resulting mixture was stirred under nitrogen for 2 hours. The mixture was poured into cold methanol (500 mL) to precipitate the product, which was isolated by vacuum filtration. The collected product was washed with additional methanol (250 mL) and finally dried in a vacuum oven at 40° C. and ˜25 in-Hg for 6 hours, yielding a white powder (namely butyl N-phenyl carbamate, M4).

As a specific, non-limiting example of the synthesis of small-molecule urethane decrosslinker F1, in one embodiment, 2-hydroxyethyl methacrylate (HEMA, 6.008 g, 0.04618 mol, 1.1 equiv.) was added to a 100 mL flame-dried round bottom flask equipped with a magnetic stir bar, nitrogen inlet, nitrogen outlet, and rubber septa, which was conditioned over an ice bath. Anhydrous DCM (80 mL), phenyl isocyanate (5.000 g, 0.04198 mol, 1.0 equiv.), and DBTDL (0.133 g, 0.000210 mol, 0.005 equiv.) were added to the flask via syringe, and the resulting mixture stirred under nitrogen 2 hours. The mixture was poured into cold hexanes (1 L) to precipitate the product, which was then isolated by vacuum filtration. The collected product was washed with additional hexanes (500 mL) and finally dried in a vacuum oven at 40° C. and ˜25 in-Hg for 6 hours, yielding a white powder (namely HEMA N-phenyl carbamate, F1).

As a specific, non-limiting example of the synthesis of small-molecule urethane decrosslinker F2, in one embodiment, 9-anthracenemethanol (9.618 g, 0.04618 mol, 1.1 equiv.) was added to a flame-dried 100 mL round bottom flask equipped with a magnetic stir bar, nitrogen inlet, nitrogen outlet, and rubber septa, which was conditioned over an ice bath. Anhydrous DCM (80 mL) was added to the flask to completely dissolve the solid 9-anthracenemethanol. Phenyl isocyanate (5.000 g, 0.04198 mol, 1.0 equiv.) and DBTDL (0.133 g, 0.000210 mol, 0.005 equiv.) were added to the flask via syringe, and the resulting mixture was stirred under nitrogen for 2 hours. The mixture was poured into cold hexanes (1 L) to precipitate the product, which was then isolated by vacuum filtration. The collected product was washed with additional hexanes (500 mL) and finally dried in a vacuum oven at 40° C. and ˜25 in-Hg for 6 hours, yielding a yellow powder (namely anthracenemethanol N-phenyl carbamate, F2).

As a specific, non-limiting example of the synthesis of small-molecule urethane decrosslinker F3, in one embodiment, cinnamyl alcohol (6.197 g, 0.04618 mol, 1.1 equiv.) was added to a flame-dried round bottom flask equipped with a magnetic stir bar, nitrogen inlet, nitrogen outlet, and rubber septa, which was conditioned in an ice bath. Anhydrous DCM (80 mL) was added to the flask to completely dissolve the alcohol. Phenyl isocyanate (5.000 g, 0.04198 mol, 1.0 equiv.) and DBTDL (0.133 g, 0.000210 mol, 0.005 equiv.) were added to the flask via syringe and the resulting mixture stirred under nitrogen for 2 hours. The mixture was poured into cold hexanes (1 L) to precipitate the product, which was then isolated by vacuum filtration. The collected product was washed with additional hexanes (500 mL) and finally dried in a vacuum oven at 40° C. and ˜25 in-Hg for 6 hours yielding a white powder (namely cinnamyl N-phenyl carbamate, F3).

As a specific, non-limiting example of the deconstruction of model crosslinked PU films with M1, in one embodiment, in a typical M1-assisted extrusion process, ground, dry model PU films (3.500 g, 0.008233 mol urethane bonds) were hand mixed with small-molecule carbamate decrosslinker M1 (1.069 g, 0.002744 mol; 25.0 mol % of the total amount of the total amount of carbamate linkages in the feed mixture, corresponding to 22.0 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After controlled amounts of mixing time (e.g., 5, 8, 13, and 23 min), the material was extruded to stop the experiment. Time-dependent normal force values were recorded as reported by the instrument.

Notably, 8 min-long extrusion experiments were performed at a series of M1 loadings, ranging from 2.6-33.3 mol % of the total amount of the total amount of carbamate linkages in the feed mixture (corresponding to 2.3-29.6 wt % of the total feed mixture). At 2.6 mol % of M1, the resulting extrudates were crosslinked and reported a gel fraction of ˜64 wt %, according to swelling tests in a similar manner. At 9.6 mol % of M1, the resulting extrudates were decrosslinked.

As a specific, non-limiting example of the deconstruction of model crosslinked PU films with M2, in one embodiment, M2 was used to decrosslink model crosslinked PU films in a similar manner. Specifically, ground, dry model PU films (3.500 g, 0.008233 mol urethane bonds) were hand mixed with small-molecule carbamate decrosslinker M2 (1.069 g, 0.002744 mol; 25.0 mol % of the total amount of carbamate linkages in the feed mixture, corresponding to 22.3 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and extruded.

As a specific, non-limiting example of the deconstruction of model crosslinked PU films with M3, in one embodiment, M3 was used to decrosslink model crosslinked PU films in a similar manner. Specifically, ground, dry model PU films (3.500 g, 0.008233 mol urethane bonds) were hand mixed with small-molecule carbamate decrosslinker M3 (0.640 g, 0.002744 mol; 25.0 mol % of the total amount of the total amount of carbamate linkages in the feed mixture, corresponding to 14.5 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and extruded.

As a specific, non-limiting example of the deconstruction of model crosslinked PU films with M4, in one embodiment, M4 was used to decrosslink model crosslinked PU films in a similar manner. Specifically, ground, dry model PU films (3.500 g, 0.008233 mol urethane bonds) were hand mixed with small-molecule carbamate decrosslinker M4 (1.014 g, 0.002744 mol; 25.0 mol % of the total amount of the total amount of carbamate linkages in the feed mixture, corresponding to 21.2 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and extruded.

As a specific, non-limiting example of the deconstruction of model crosslinked PU films with F1, in one embodiment, F1 was used to decrosslink model crosslinked PU films and simultaneously functionalize the decrosslinked extrudates in a single-step reactive extrusion. Specifically, ground, dry model PU films (3.500 g, 0.008233 mol urethane bonds) were hand mixed with small-molecule carbamate decrosslinker F1 (0.684 g, 0.002744 mol; 25.0 mol % of the total amount of the total amount of carbamate linkages in the feed mixture, corresponding to 15.3 wt % of the total mixture), DBTDL (0.277 g, 0.000439 mol, 4.0 mol % of the total number of carbamate linkages), and BHT (1.000 g, 0.004537 mol, BHT to methacrylate molar ratio=1.6:1). The radical inhibitor BHT was introduced to suppress thermally-initiated methacrylate homopolymerization. The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and the resulting functionalized thermoplastic PU extrudate was extruded.

As a specific, non-limiting example of the deconstruction of model crosslinked PU films with F2, in one embodiment, F2 was used to decrosslink model crosslinked PU films and simultaneously functionalize the decrosslinked extrudates in a single-step reactive extrusion. Specifically, ground, dry model PU films (3.500 g, 0.008233 mol urethane bonds) were hand mixed with small-molecule carbamate decrosslinker F2 (0.899 g, 0.002744 mol; 25.0 mol % of the total amount of the total amount of carbamate linkages in the feed mixture, corresponding to 19.2 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and the resulting functionalized thermoplastic PU extrudate was extruded.

As a specific, non-limiting example of the deconstruction of model crosslinked PU films with F3, in one embodiment, F3 was used to decrosslink model crosslinked PU films and simultaneously functionalize the decrosslinked extrudates in a single-step reactive extrusion. Specifically, ground, dry model PU films (3.500 g, 0.008233 mol urethane bonds) were hand mixed with small-molecule carbamate decrosslinker F3 (0.695 g, 0.002744 mol; 25.0 mol % of the total amount of the total amount of carbamate linkages in the feed mixture, corresponding to 15.5 wt % of the total mixture) and DBTDL (0.277 g, 0.000439 mol, 4.0 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU was decrosslinked and the resulting functionalized thermoplastic PU extrudate was extruded.

As a specific, non-limiting example of the deconstruction of model crosslinked PU foams with M1, in one embodiment, similarly, model crosslinked PU foams were decrosslinked by small molecule-assisted decrosslinking extrusion. In a representative M1-assisted extrusion process, ground, dry model PU foams (3.500 g, 0.008233 mol urethane bonds) were hand mixed with small-molecule carbamate decrosslinker M1 (1.069 g, 0.002744 mol; 25.0 mol % of the total amount of the total amount of carbamate linkages in the feed mixture, corresponding to 22.0 wt % of the total mixture) and DBTDL (0.277 g, 0.000439 mol, 4 mol % of the total number of carbamate linkages). The heterogeneous mixture was fed into the hopper, then pushed into the barrel of the extruder preset to 165±10° C. at a screw speed of 50 RPM. The screw speed was increased to 150 RPM and the N₂ purge was turned on once all the mixture was fed into the extruder. The extruder was set to recirculate during both loading and melt mixing. After twin-screw mixing for 8 min, the model crosslinked PU foam was decrosslinked and extruded.

It will be understood that implementations are not limited to the specific components disclosed herein, as virtually any components consistent with the intended operation of a method and/or system implementation for upcycling polyurethane thermosets into thermoplastics via small-molecule carbamate-assisted decrosslinking extrusion may be utilized. Accordingly, for example, although particular methods, PUs, and carbamates may be disclosed, such components may comprise any shape, size, style, type, model, version, class, grade, measurement, concentration, material, weight, quantity, and/or the like consistent with the intended operation of a method and/or system implementation for upcycling polyurethane thermosets into thermoplastics via small-molecule carbamate-assisted decrosslinking extrusion may be used. In places where the description above refers to particular implementations of methods for upcycling polyurethane thermosets into thermoplastics, it should be readily apparent that a number of modifications may be made without departing from the spirit thereof and that these implementations may be applied to other upcycling/recycling methods and materials.

We claim:

1. A method for recycling polyurethane thermosets, the method comprising:
grinding a crosslinked polyurethane thermoset into granules;
feeding a mixture of the granules and a small-molecule carbamate decrosslinker into a twin-screw extruder;
heating the mixture within the extruder to a temperature between 150° C. and 220° C.;
introducing a catalyst into the extruder;
catalyzing carbamate exchange reactions within the extruder between the polyurethane thermoset and the decrosslinker; and
extruding the mixture as a thermoplastic material.

2. The method of claim 1, wherein the small-molecule carbamate decrosslinker is selected from the group consisting of stearyl N-phenyl carbamate, stearyl N-cyclohexyl carbamate, benzyl N-cyclohexyl carbamate, stearyl N-butyl carbamate, hydroxyethyl methacrylate N-phenyl carbamate, anthracenemethanol N-phenyl carbamate, and cinnamyl N-phenyl carbamate.

3. The method of claim 1, wherein the catalyst is selected from the group consisting of dibutyltin dilaurate, zirconium (IV) acetylacetonate, and bismuth neodecanoate.

4. The method of claim 1, wherein the small-molecule carbamate decrosslinker comprises a functional group selected from the group consisting of methacrylate, acrylate, epoxy, silane, anthracene, and stilbene.

5. The method of claim 1, further comprising purifying the thermoplastic material to remove residual catalyst and unreacted decrosslinker.

6. The method of claim 1, wherein the granules have an average particle diameter of 1.5 millimeters.

7. A method for recycling polyurethane thermosets, the method comprising:
contacting a crosslinked polyurethane thermoset with a small-molecule carbamate decrosslinker to form a mixture;
introducing a catalyst into the mixture;
heating the mixture to a temperature sufficient to catalyze carbamate exchange reactions between the polyurethane thermoset and the decrosslinker; and
recovering a decrosslinked polyurethane as a thermoplastic material.

8. The method of claim 7, wherein the thermoplastic material is solvent-processable in a solvent selected from the group consisting of tetrahydrofuran (THF), dichloromethane (DCM), and acetone.

9. The method of claim 7, wherein the small-molecule carbamate decrosslinker is selected from the group consisting of hydroxyethyl methacrylate N-phenyl carbamate, anthracenemethanol N-phenyl carbamate, and cinnamyl N-phenyl carbamate.

10. The method of claim 7, wherein the catalyst comprises a Lewis acid suitable for catalyzing carbamate exchange reactions.

11. The method of claim 7, wherein the molecular weight or viscosity of the thermoplastic material is controlled by the concentration of the small-molecule carbamate decrosslinker.

12. The method of claim 7, further comprising purifying the thermoplastic material to remove residual catalyst and unreacted decrosslinker.

13. The method of claim 7, wherein the temperature is between 150° C. and 220° C.

14. The method of claim 7, wherein the mixture is fed into a twin-screw extruder.

15. A composition comprising:
decrosslinked polyurethane chains derived from a crosslinked polyurethane thermoset, wherein the composition is melt-processable and solvent-soluble.

16. The composition of claim 15, wherein the decrosslinked polyurethane chains have a hydrodynamic diameter of from about 2 nm to about 10 nm.

17. The composition of claim 15, wherein the composition has a gel fraction of less than about 10 wt %.

18. The composition of claim 15, wherein the composition has a melt viscosity of less than about 100 Pa·s at 80° C.

19. The composition of claim 15, wherein the decrosslinked polyurethane chains comprise one or more chain-end functional groups selected from methacrylate, anthracene, stilbene, vinyl, allyl, or thiol.

20. The composition of claim 15, wherein the composition comprises polyurethane chains with a controlled molecular weight and chain-end functionality without requiring further purification.
